(19) United States
(12) Patent Application Publication
(10) Pub. No.: US 2018/0185996 A1
(43) Pub. Date: Jul. 5, 2018

(54) SCREWING DEVICE AND SCREW

(71) Applicant: Hilti Aktiengesellschaft, Schaan (LI)

(72) Inventor: Thomas FOSER, Balzers (LI)

(21) Appl. No.: 15/553,333

(22) PCT Filed: Feb. 24, 2016
(86) PCT No.: PCT/EP2016/053847

§ 371 Date: Aug. 24, 2017

(30) Foreign Application Priority Data
Mar. 2, 2015 (EP) 15157172.6
Nov. 4, 2015 (EP) 15192985.8

(51) Int. Cl. B25B 23/00; B25B 23/12; B25B 21/00; B25B 23/14; F16B 25/00; F16B 35/04

(52) U.S. Cl. CPC B25B 23/0064; B25B 23/12; F16B 35/048; B25B 23/141; F16B 25/0052; B25B 21/00

(57) ABSTRACT

A device for screwing a screw into a substrate comprises a coupling having a rotationally drivable coupling input and a coupling output, the coupling input, when engaged, is connected to the coupling output in a torque-transmitting manner, and the coupling input, when disengaged, is freely rotatable with respect to the coupling output. The device further comprises a displacement limiter for limiting movement of the coupling input in the placement direction, the displacement limiter comprising a substrate support for placement on the substrate and a stop for contact with the coupling input. The distance between the substrate support and the stop measured in the placement direction is adapted to the dimensions of the coupling input, of the coupling output and of the screw in such a manner that the coupling is disengaged when the screw is screwed into the substrate to a predetermined placement depth.

The present invention relates to a device for screwing a screw into a substrate as well as such a screw.

Screws usually have a fastening section for screwing the screw in a direction of placement into a substrate as well as having a head with a screw drive. There are known screws, which also have an attachment section for fastening a mounting part on the screw, wherein the attachment section is often embodied as a thread.

In some applications, it is desirable not to exceed or fall below a predetermined screwing depth of a screw into the substrate. To ensure the predetermined screwing depth, displacement limiters, which limit the forward advance of a screwing device while screwing the screw into the substrate, are used, so that the screw is disengaged from the screwing device on reaching the desired screwing depth. However, the design of such screwing devices is extremely complicated and they cannot otherwise be used for each individual application. Furthermore, the screwing depth cannot be predefined with the desired accuracy and changes over time due to wear, for example.

One object of the invention is to make available a device for screwing a screw into a substrate as well as such a screw, with which an accurate displacement limitation is implemented in a simple manner.

According to a first aspect of the invention, a device for screwing a screw into a substrate in a direction of placement comprises a coupling with a coupling input that can be driven to rotate and a coupling output, wherein the coupling input is connected to the coupling output in a torque-transmitting manner during the coupling state of the coupling and in a disengaged state of the coupling, the coupling input is freely rotatable with respect to the coupling output and wherein the coupling is disengaged when the coupling output, starting from a coupled state of the coupling, is moved away from the coupling input beyond a predetermined extent in the direction of placement of the coupling input. The coupling input here has an insertion end for insertion into a drill chuck of a screwing device. In addition, the device comprises a displacement limiter for limiting a movement of the coupling input in the direction of placement, wherein the displacement limiter has a substrate support for contact with the substrate and a stop for contact with the coupling input. The distance measured in the direction of placement between the substrate support and the stop is adapted to the dimensions of the coupling input, the coupling output and the screw, such that the coupling is disengaged when the screw has been screwed into the substrate by a certain predetermined depth of placement. This object is achieved by an adjusting device, by means of which the distance between the substrate support and the stop can be adjusted, as measured in the direction of placement. In this way, unwanted deviations from the predetermined screwing depth can be compensated.

A preferred embodiment is characterized in that the displacement limiter comprises a support part having the substrate support and a stop part including the stop, wherein the adjusting device comprises a first thread on the support part and a second thread on the stop part, and wherein the first thread and the second thread are screwed together, so that twisting of the supporting part with respect to the stop part will cause a change in the measured distance in the direction of placement between the substrate support and the stop, as measured in the direction of placement. The support part and/or the stop part especially preferably comprise(s) a guide sleeve for the screw.

A preferred embodiment is characterized in that the adjusting device comprises a catch device which engages at one or more different distances measured between the substrate support and the stop as measured in the direction of placement. This counteracts any unwanted misadjustment of the distance between the substrate support and the stop.

A preferred embodiment is characterized in that the coupling comprises a coupling spring which preloads the coupling in its disengaged state. A spring force of the coupling spring especially preferably acts on the coupling output and preloads the coupling output away from the coupling input.

A preferred embodiment is characterized in that the coupling input comprises one or more claws on the input end, and wherein the coupling output comprises one or more claws on the output end, and wherein the claws on the input end and the claws on the output end engage in one another for torque-transmitting connection of the coupling input to the coupling output.

A preferred embodiment is characterized in that the coupling output comprises the head of the screw and wherein the coupling input comprises a receptacle for the head. The head of the screw is then disengaged directly from the receptacle. According to one alternative embodiment, the coupling output comprises a receptacle for the head of the screw. The receptacle is then disengaged from the coupling input together with the head of the screw accommodated therein. The receptacle especially preferably comprises a drive bit, which is preferably embodied as an internal polygon socket for transmitting torque from the receptacle to the head of the screw.

A preferred embodiment is characterized in that the receptacle has a guide section which becomes steadily wider in the direction of placement for guiding a transitional section of the screw connected to the head of the screw. The guide section especially preferably becomes wider conically in the direction of placement. Under some circumstances, a guide for the screw contributes to an improved constancy in the depth of placement of the screw into the substrate.

A preferred embodiment is characterized in that the adjusting direction comprises an adjusting stop which limits an adjusting lift, i.e., a maximum displacement of the adjusting device. The stop part preferably has the adjusting stop. Alternatively the support part has the adjusting stop.

According to another aspect of the invention, a screw has a fastening section for screwing the screw into a substrate in the direction of placement, an attachment section for fastening a mounting part onto the screw and a head, which has a screw drive that is preferably embodied as an external polygon head. This object is achieved by a transitional section, which becomes steadily wider in the direction of placement and which is connected to the head in the direction of placement. The transitional section preferably becomes wider conically in the direction of placement. The screw can be guided on the transitional section, which becomes steadily wider and, under some circumstances, contributes toward an improved constancy of the screwing depth of the screw into the substrate.

A preferred embodiment is characterized in that one dimension of the screw transversely to the direction of placement, especially preferably at a right angle to the direction of placement becomes steadily larger from the head to the attachment section. Preventing unsteady locations results in facilitated guidance of the screw and under some circumstances leads to a reduction in jamming of the screw in the guide of the screwing device.

A preferred embodiment is characterized in that the attachment section has an attachment thread for screwing the mounting part on the screw.

Preferred embodiments are explained in greater detail below with reference to the accompanying drawings, in which:

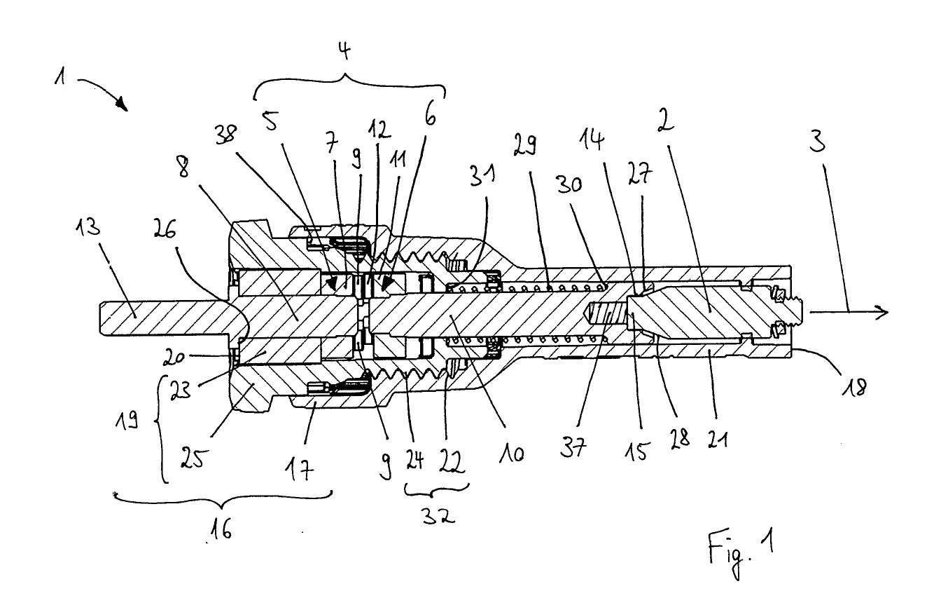

FIG. 1 shows a device for screwing a screw into a substrate in the direction of placement in a longitudinal sectional view,

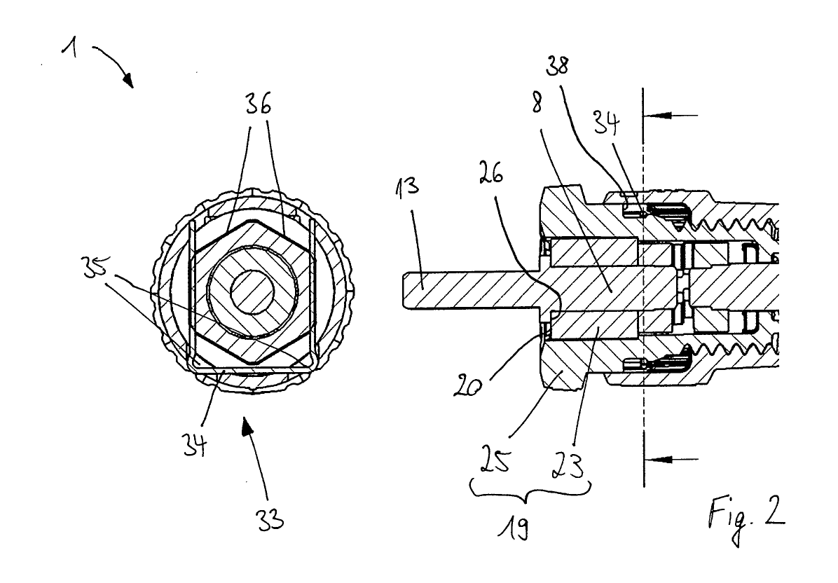

FIG. 2 shows the device from FIG. 1 in a partial longitudinal sectional view as well as in a cross-sectional view, and

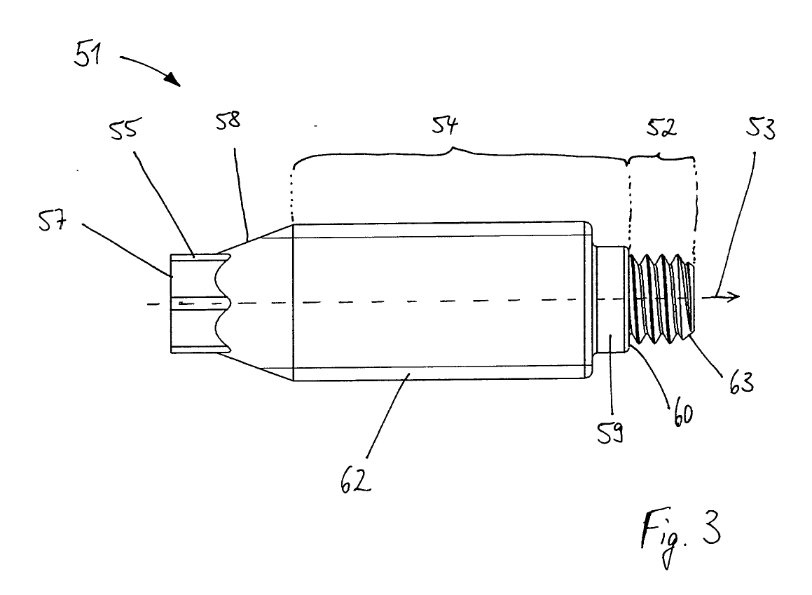

FIG. 3 shows a screw in a side view.

FIGS. 1 and 2 show a screwing device 1 for screwing a screw 2 into a substrate (not shown) in the placement direction 3. The screwing device 1 comprises a coupling 4 with a rotatably drivable coupling input 5 and a coupling output 6. The coupling input 5 comprises a drive shaft 8 with an insertion end 13 and a drive ring 7 which is preferably fastened thereto by a press fit and is rigidly connected thereto. The drive ring 7 has four claws 9 on the input end. The coupling output 6 comprises an output shaft 10 with a receptacle 14 for a head 15 of the screw 2 and an output ring 11 which is preferably fastened thereto by a press fit and is rigidly connected thereto. The output ring 11 has four claws 12 on the output end. The receptacle 14 has a guide section 27, which steadily becomes wider conically in the direction of placement 3, and serves to guide the guide ring of a transitional section 28 of the screw connected to the head 15 of the screw 2. The receptacle 4 has an internal hexagon socket or a round internal hexagon socket. The head 15 of the screw 2 accordingly has an external hexagon head or a round hexagon socket. A magnet 37 is fastened in a recess, preferably in a bore in the output shaft, so that the screw 2 is held more securely in the receptacle 14 under some circumstances.

In particular to prevent any sticking of the claws on the input end and the claws on the output end, the claws on the input end and/or the claws on the output end are provided with an adhesive grease. In exemplary embodiments (not shown here), the coupling input has one, two, three or more than four claws on the input end, and the coupling output accordingly has one, two, three or more than four claws on the output end.

In addition, the screwing device 1 comprises a displacement limiter 16 for limiting movement of the coupling input 5 in the direction of placement 3. The displacement limiter 16 comprises a support part 17 with a substrate support 18 for contact with the substrate (not shown) as well as a stop part 19 with a stop 20 for contact with the coupling input 5. The stop 20 is situated on a counter stop 26 of the drive shaft 8 opposite the direction of placement. The support part 17 has a guide sleeve 21, whose end face forms the substrate support 18 in the direction of placement as well as having an internal thread 22. The stop part 19 has a press-on sleeve 23, whose end face forms the stop 20 opposite the direction of placement, and a thread sleeve 25 with an external thread 24. The drive shaft 8 is mounted so that it can rotate freely in the press-on sleeve 23.

The coupling 4 is at least partially accommodated in the thread sleeve 25 and comprises a coupling spring 29, which preloads the coupling 4 in the disengaged state, as illustrated in FIG. 1, in that a spring force of the coupling spring 29, on the one hand, acts on the coupling output 6, preferably on a first shoulder 30 of the coupling output 6 facing opposite the direction of placement 3 and, on the other hand, acts on the coupling input 5, preferably on a second shoulder 31, which faces in the direction of placement 3, on the coupling input 5. The coupling spring 29 presses the first shoulder 30 and the second shoulder 31 apart from one another and thus preloads the coupling output 6 away from the coupling input 5.

For screwing the screw 2 into the substrate (not shown), first the insertion end 13 is inserted into a drill chuck of a screwing device (not shown) and is thereby driven to rotate as soon as the screwing device is turned on. Since the coupling 4 is preloaded by the coupling spring 29 in its disengaged state, only the coupling input 5 with the drive shaft 8 and the drive ring 7 having the claws 9 on the input end is driven to rotate. As soon as the screwing mechanism together with the screwing device 1 is pressed against the substrate in such a way that the substrate support 18 rests on the substrate, the spring force of the coupling spring 29 is overcome, so that the coupling input 5 moves toward the coupling output 6. As soon as the claws 9 on the input end and the claws 12 on the output end mesh with one another, a torque is transferred from the coupling input 5 to the coupling output 6 and thus from the screwing device by way of the coupling 4 and the receptacle 14 to the screw 2, which is ultimately screwed into the substrate or into a prefabricated bore in the substrate.

During the entire screwing process, a predetermined distance between the coupling input 5 and the substrate is ensured by the displacement limiter 16, i.e., by the distance between the substrate support 18 and the stop 20 in the direction of placement 3. The screw 2 with its head 15 moves toward the substrate but the receptacle 14 conforms to the advance of the screw 2 by means of the coupling spring 29. The screw 2 is driven to rotate over the receptacle 14 until the claws 12 on the output end are disengaged from the claws 9 on the input end. The coupling output 6 has then moved away from the coupling input 5 beyond a predetermined extent in the direction of placement 3. The distance between the substrate support 18 and the stop 20 as measured in the direction of placement is thereby adapted to the dimensions of the coupling input 5, the coupling output 6 and the screw 2, so that the coupling 4 is disengaged precisely when the screw 2 has been screwed into the substrate by a predetermined depth of placement.

With the help of an adjusting device 32 comprising the internal thread 22 and the external thread 24, the distance between the substrate support 18 and the stop 20 is measured in the direction of placement 3 screwing depth of the screw 2 into the substrate can be adjusted. The internal thread 22 and the external thread 24 are screwed together so that any twisting of the support part 17 with respect to the stop part 19 then causes a change in the screwing depth. The adjusting device additionally comprises an adjusting stop 38, which limits the adjustment stroke of the adjusting device 32 to 3 mm, for example. In the present case, the stop part 19 has the adjusting stop 38. In embodiments not shown here the support part has the adjusting stop.

A catch device 33 serves to provide a lock during the adjustment of the adjusting device 32 and has a catch spring 34, which, on the one hand, is supported in multiple recesses 35 on the inside of the support part 17 and, on the other hand, is supported onto flattened areas 36 on the outside of the thread sleeve 25 of the stop part 19. For twisting of the support part 17 with respect to the stop part 19 a predetermined resistance force must be overcome in order to deform the catch spring 34 accordingly and allow it to engage in the next flattened area 36.

FIG. 3 shows one embodiment of a screw 51 in a side view drawn to scale. The bolt-shaped screw 51 comprises a fastening section 52 for screwing into a bore in a substrate (not shown) along a direction of placement 53 and an attachment section 54 for arrangement outside of the bore and a head 57 with a screw drive 55 formed as an external hexagon head for applying a torque to the screw 51. The fastening section 52 has a self-tapping thread section 56 for tapping, in particular cutting an internal thread into the bore. The attachment section 54 has an attachment thread 64 for screwing a mounting part (not shown) for example a screw nut onto the screw 51. The attachment thread has an outside diameter of 8 mm for example.

The screw 51 additionally comprises a transitional section 58 which becomes wider steadily in the direction of placement and is connected to the head 57 in the direction of placement 53. The attachment section 54 is again connected to the transitional section 58 so that the diameter of the screw 51 become steadily larger from the head 57 to the attachment section 54 as measured in the direction of placement 53.

The fastening section 52 has a thread length in the direction of placement 53 of 2.5 mm. The one-piece screw 51 consists of stainless steel which is preferably inductively hardened and/or is preferably stainless and has a material hardness of at least 800 MPa, for example 1,000 MPa. The attachment section 54 has a collar 59 with a stop 60 on which a sealing element can be arranged which seals the bore and/or the interspace between the bore and the screw 51 with respect to the surroundings after the fastening element has been fastened onto the fastening object. In embodiments which are not shown here, the fastening section is connected directly to the attachment thread without a collar in between. The thread length of the fastening section then amounts to 6.1 mm for example.

To manufacture the screw 51, the interface geometry 55 is applied to a semifinished product using a shaping method and a self-tapping thread for creating the fastening section 52 is applied to a semifinished product by using a rolling method. Next a bevel 63 is created on the front end face of the semifinished product using a milling method wherein the self-tapping thread and the bevel 63 preferably overlap to form a thread lead-in and an external thread.

The present invention has been illustrated on the example of a screwing device but it is pointed out that the device according to the invention is also suitable for other intended applications. In addition the features of the individual embodiments described here may also be combined in any desired manner within a single embodiment inasmuch as they are not mutually exclusively.

1. A device for screwing a screw into a substrate in a direction of placement, comprising an adjusting device; a coupling with a coupling input that can be driven to rotate, and a coupling output, wherein the coupling input is connected to the coupling output in a torque-transmitting manner in a coupled condition of coupling, and in a disengaged condition of coupling, the coupling input is freely rotatable with respect to the coupling output, and wherein the coupling is disengaged when the coupling output moves away from the coupling input in the direction of placement beyond a predetermined extent, starting from the coupled condition, wherein the coupling input has an insertion end for insertion into a drill chuck of a screwing device, additionally comprising a displacement limiter for limiting displacement of the coupling input in the direction of placement, wherein the displacement limiter has a substrate support for contact with the substrate and a stop for contact with the coupling input, and wherein a distance between the substrate support and the stop is adapted to dimensions of the coupling input, the coupling output and the screw, as measured in the direction of placement, in such a way that the coupling is disengaged when the screw is screwed into the substrate for a predetermined placement depth, wherein, by using the adjusting device, the distance between the substrate support and the stop is adjustable as measured in the direction of placement.

2. The device according to claim 1, wherein the displacement limiter comprises a support part having the substrate support and a stop part having the stop and wherein the adjusting device comprises a first thread on the support part and a second thread on the stop part and wherein the first thread and the second thread are screwed together so that twisting of the support part with respect to the stop part causes a change in the distance between the substrate support and the stop as measured in the direction of placement.

3. The device according to claim 2, wherein the support part and/or the stop part comprise(s) a guide sleeve for the screw.

4. The device according to claim 1, wherein the adjusting device comprises a catch device which engages at one or more different distances between the substrate support and the stop as measured in the direction of placement.

5. The device according to claim 1, wherein the coupling comprises a coupling spring which preloads the coupling in the disengaged condition.

6. The device according to claim 5, wherein a spring force of the coupling spring acts on the coupling output and preloads the coupling output away from the coupling input.

7. The device according to claim 1, wherein the coupling input has an input end and comprises one or more claws on the input end and wherein the coupling output has an output end and comprises one or more claws on the output end and wherein the claws on the input end and the claws on the output end mesh with one another for a torque-transmitting connection of the coupling input to the coupling output.

8. The device according to claim 1, wherein the coupling output comprises a head of the screw and wherein the coupling input comprises a receptacle for the head of the screw.

9. The device according to claim 1, wherein the coupling output comprises a receptacle for a head of the screw.

10. The device according to claim 8, wherein the receptacle comprises a drive bit designed for transmitting torque from the receptacle to the head of the screw.

11. The device according to claim 8, wherein the receptacle has a guide section which becomes wider in the direction of placement.

12. The device according to claim 1, wherein the adjusting device comprises an adjusting stop which limits an adjusting stroke of the adjusting device.

13. A screw having a fastening section for screwing the screw into a substrate in a direction of placement, the screw having an attachment section for fastening a mounting part onto the screw and having a head, which has a screw drive having a transitional section which becomes wider in the direction of placement.

14. The screw according to claim 13, wherein one dimension of the screw transversely to the direction of placement becomes larger from the head to the attachment section.

15. The screw according to claim 13, wherein the attachment section has an attachment thread for screwing the mounting part onto the screw.

16. The device of claim 10, wherein the drill bit comprises an internal polygon socket or an internal round socket.

17. The device of claim 11, wherein the guide section becomes wider conically for guiding the transitional section of the screw connected to the head of the screw.

18. The screw of claim 13, wherein the screw drive comprises an external polygon head or an external round head.

19. The screw of claim 13, wherein the transitional section becomes wider conically and is connected to the head in the direction of placement.

20. The screw according to claim 14, wherein the dimension of the screw transversely to the direction of placement is at a right angle to the direction of placement.
